(19) United States
(12) Patent Application Publication
(10) Pub. No.: US 2014/0359415 A1
(43) Pub. Date: Dec. 4, 2014

(54) Screen Scraping Method and Scraping Management Server

(71) Applicant: SECHANG INSTRUMENTS CO., LTD., Seoul (KR)

(72) Inventors: Seung June Song, Seoul (KR); Seung Ic Lee, Gyeongsangbuk-do (KR); Seung Taek Song, Gyeonggi-do (KR)

(73) Assignee: SECHANG INSTRUMENTS CO., LTD., Seoul (KR)

(21) Appl. No.: 14/348,042

(22) PCT Filed: Sep. 28, 2012
(86) PCT No.: PCT/KR2012/007926

§ 371 Date: Jul. 15, 2014

(30) Foreign Application Priority Data
Sep. 28, 2011 (KR) 10-2011-0097999

(51) Int. Cl. G06F 17/22

(52) U.S. Cl. CPC G06F 17/2235; G06F 17/2229
USPC 715/206

(57) ABSTRACT

According to method for scrapbooking web pages by the present invention, firstly scrapbooking service apparatus 500 of user computer 50 captures region on the web page outputted to the user computer, makes it into an image file and receives memo, then transfers them with URL of the web page to scrapbooking service server 100. The scrapbooking service sever 100 publishes the transferred capture image of the web page, the memo and the link to the URL of the web page on the electronic bulletin board as a post.

### BACKGROUND OF THE INVENTION

The present invention relates to method for scrapbooking screens and management server implementing the scrapbooking of screens.

Desires to store good web-pages found during web-surfing and see it at necessary time exist. Also, desires to share the good web pages with others and to talk about it exist. These desires are directed to numbers of web pages and not limited to one web page.

Accordingly, it is necessary to make it possible to scrapbook numbers of web pages and find the scrapbooked web pages easily, and to share them with others.

In connection with scrapbooking of the web pages, for example, Korean patent application No. 10-2000-0057703, the title of which is “Scrapbooking method using Internet” is found.

In connection with scrapbooking of the web pages, the following conditions are necessary:

Firstly, it should be possible to easily scrapbook web pages that the user wants.

Secondly, it should be possible to easily find and access the scrapbooked web pages and, preferably, easily share them.

Thirdly, it should be possible to contain the contents of the original web pages faithfully in order to see them when they are necessary.

Meanwhile, it is preferable if the user can introduce videos, images, flashes or documents on computer to and talk about them with others and share them.

The present invention satisfies these demands and provides method for scrapbooking screens which makes it possible for users to easily scrapbook web pages, easily and conveniently find numbers of the scrapbooked web pages, share them with others and see the original web pages later. Further, the present invention makes it possible to introduce videos, images, flashes or documents on computer to and share them with others.

### SUMMARY OF THE INVENTION

The purpose of the present invention is to provide method for scrapbooking web pages and server for scrapbooking web pages which make it possible for users to easily scrapbook web pages, easily and conveniently find numbers of the scrapbooked web pages, share them with others and see the original web pages later.

Further, the present invention provides method for scrapbooking web pages and server for scrapbooking web pages which make it possible for users to introduce videos, images, flashes or documents on computer to and share them with others.

The present invention provides method for scrapbooking web page comprising the steps of: Web page screen output step wherein a web page according to URL to which a user computer accesses is outputted to the user computer; wherein the user computer has a web browser and scrapbooking service apparatus, capture step wherein the scrapbooking service apparatus captures region established by a user on the web page outputted to the user computer and makes the captured region into an image file, and reads the URL of the web page; capture image transfer step wherein the scrapbooking service apparatus transfers the image file and the URL of the web page to a scrapbooking service server; database storage step wherein the scrapbooking service server stores the transferred image file captured from the web page and the URL of the web page on a database; bulletin board output step wherein the image captured from the web page and link to the URL of the web page, the image and the URL stored on the database, are outputted to the user computer or another user's computer which accesses the scrapbooking service server as a post of an electronic bulletin board.

According to the present invention, it is preferable that the capture step further includes memo read step wherein the scrapbooking service apparatus reads memo inputted to input means for memo outputted to the user computer, the capture image transfer step is that the scrapbooking service apparatus transfers the memo along with the image file and the URL of the web page and the bulletin board output step is to post the memo along with the image captured from the web page and the link to the URL of the web page.

According to the present invention, it is preferable that the user of the user computer or another user of another user computer accesses the URL of the web page through the link to the URL of the web page and sees the original web page.

According to the present invention, it is preferable that capturing region established by a user on the web page outputted to the user computer and making the captured region into the image file by the scrapbooking service apparatus includes that, when the user selects a particular image outputted to the user computer by means of an input device for establishing region for capture, the scrapbooking service apparatus analyses DOM structure of the web page and calculates position values of the selected image and captures the region according to the position values, that the scrapbooking service apparatus extracts objects according to meta data or that, when the user designates particular region on the web page outputted to the user computer by means of the input device for establishing region for capture, the scrapbooking service apparatus calculates the position values of the designated region and captures the region according to the position values.

According to the present invention, it is preferable that the method for scrapbooking web page further comprising the steps of: Capture of output of user computer and transfer step wherein the scrapbooking service apparatus captures region established by the user on the output display other than the web page outputted to the user computer and makes the captured into an image file, reads a memo inputted to input means for memo outputted to the user computer and transfers the capture image and the memo to the scrapbooking service server; database storage step wherein the scrapbooking service server stores the transferred image file captured from the output of the user computer and the memo on a database; and bulletin board output step wherein the image captured from the output of the user computer and the memo stored on the database are outputted to the user computer or another user's computer which accesses the scrapbooking service server as a post of the electronic bulletin board.

According to the present invention, it is preferable that the output of the user computer includes one selected from videos, images, flashes or documents or combination of them.

The present invention also provides method for scrapbooking web page performed by a scrapbooking service server comprising the steps of: database storage step wherein an image file and URL of a web page are stored on a database, the image file and the URL of the webpage produced and transferred to the scrapbooking service server in such a way that when the web page according to the URL to which a user computer accesses is outputted to the user computer having a web browser and scrapbooking service apparatus, the scrapbooking service apparatus captures region established by a user on the web page outputted to the user computer and makes the captured region into the image file, and reads the URL of the web page, and the scrapbooking service apparatus transfers the image file and the URL of the web page thereto; bulletin board output step wherein the image captured from the web page and link to the URL of the web page, the image and the URL stored on the database, are outputted to the user computer or another user's computer as a post of an electronic bulletin board.

According to the present invention, it is preferable that the method for scrapbooking web page performed by a scrapbooking service server further comprising the steps of: database storage of output display step wherein an image file and a memo are stored on a database, the image file and the memo produced and transferred to the scrapbooking service server in such a way that the scrapbooking service apparatus captures region established by the user on the output display other than the web page outputted to the user computer and makes the captured into the image file, reads the memo inputted to input means for memo outputted to the user computer and transfers the capture image and the memo thereto; bulletin board output step wherein the image captured from the output of the user computer and the memo stored on the database are outputted to the user computer or another user's computer as a post of the electronic bulletin board.

According to the present invention, it is preferable that the database storage step is to store a memo along with the image file and the URL of the webpage on the database, the memo produced and transferred to the scrapbooking service server in such a way that the scrapbooking service apparatus reads the memo inputted to input means for memo outputted to the user computer and transfers thereto as well as capturing the region and making the captured region into the image file, and reading the URL of the web page, and transferring the image file and the URL of the web page thereto and the Bulletin board output step is to output the memo along with the image captured from the web page and link to the URL of the web page as the post of the electronic bulletin board.

According to the present invention, users can easily scrapbook web pages only by establishing region for capture. Also, the captured web pages are posted on electronic bulletin board and comments are added thereto so that the users can easily find the scrapbooked web pages and share them with others.

Further, according to the present invention, each post with respect to the scrapbooked web pages has URL link to the original web page so that users can access the original web page and see it.

Especially, according to the present invention, as the region of the web page is captured to be posted on the bulletin board, user will capture the region which can express the subject or is the significant part of the web page. Therefore, the image of the captured web page posted on the bulletin board is the most effective cover page expressing the identity of the scrapbooked web page very well. The user can capture the part which the user wants and has interest in from the displayed screen regardless of particular metadata (image, text and video objects). For example, a photo on the web page can be captured or a part of the photo and a part of the description to the photo on the web page can be captured at the same time.

Especially, according to the present invention, a memo is written along with the capture of some region of the web page and the memo with the captured image of the web page is posted so that the posted scrapbooked web page shows the identity very well.

Accordingly, the present invention provides the way to scrapbook the web page in such a way to show its identity very well and search it easily.

Further, the present invention makes it possible to capture videos, images, flashes or documents besides web pages, upload the captured on the scrapbooking service server to output them as posts and introduce them to and share them with others.

### BRIEF DESCRIPTION OF THE DRAWINGS

FIG. 1 is a view showing scrapbooking system for screens according to the present invention;

FIG. 2 is a view showing processes of scrapbooking web page by capturing some region thereof established by a user;

FIG. 3 is a view showing step S2 of FIG. 2;

FIG. 4 is an example of an electronic bulletin board provided by scrapbooking service server for screen according to the present invention;

FIG. 5 is a view showing processes of scrapbooking output of a user computer rather than the web page; and

FIG. 6 is a view showing step S1 of FIG. 5.

### DETAILED DESCRIPTION

Now the preferred embodiment of the present invention is described with reference to accompanying drawings.

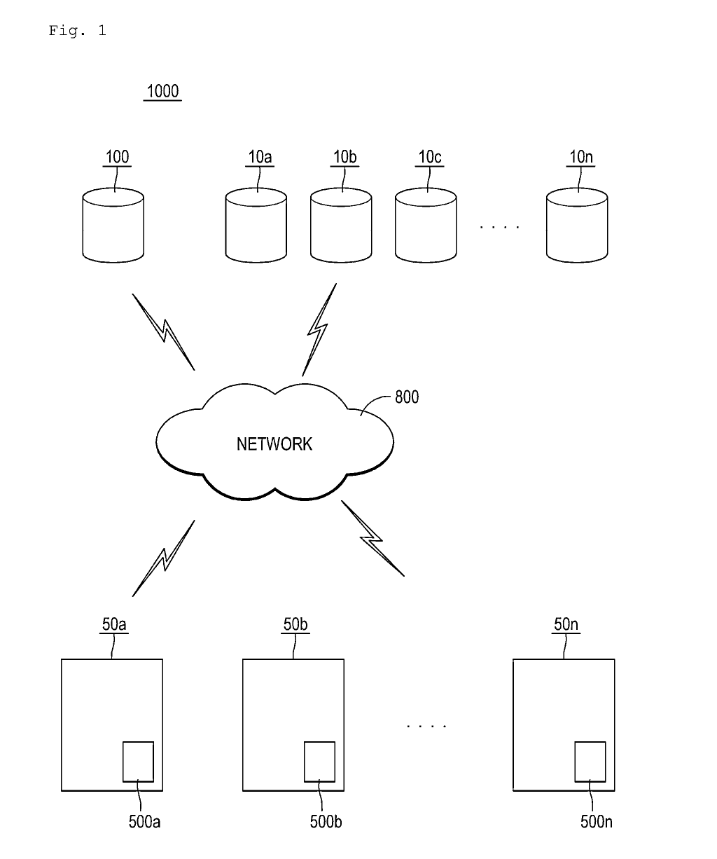

FIG. 1 shows an example of scrapbooking system for screens 1000 to which the present invention is applied.

Scrapbooking system for screen 1000 has a scrapbooking service server for screen 100 and user computers 50a, 50b . . . 50n are connected to the sever 100 through network 800.

Each of the user computers 50a, 50b . . . 50n has a web browser (not shown) and a scrapbooking service apparatus 500a, 500b . . . 500n. The scrapbooking service apparatus 500a, 500b . . . 500n can be installed independently of the web browser, or plugged-in to the web browser as the extension, or internally installed in the web browser itself.

Websites 10a, 10b, . . . 10n are provided and they are servers which the user computers 50a, 50b, . . . 50n access through network 800.

According to the present invention, the user computers 50a, 50b, . . . 50n are not limited to the personal computers and includes all communication-terminals such as mobile phones like smart phones or PDAs all which can connect to the servers 100, 100S1, 100S2, 100S3. . . 100SN, 10a, 10b, 10c, . . . ,10n through network 800.

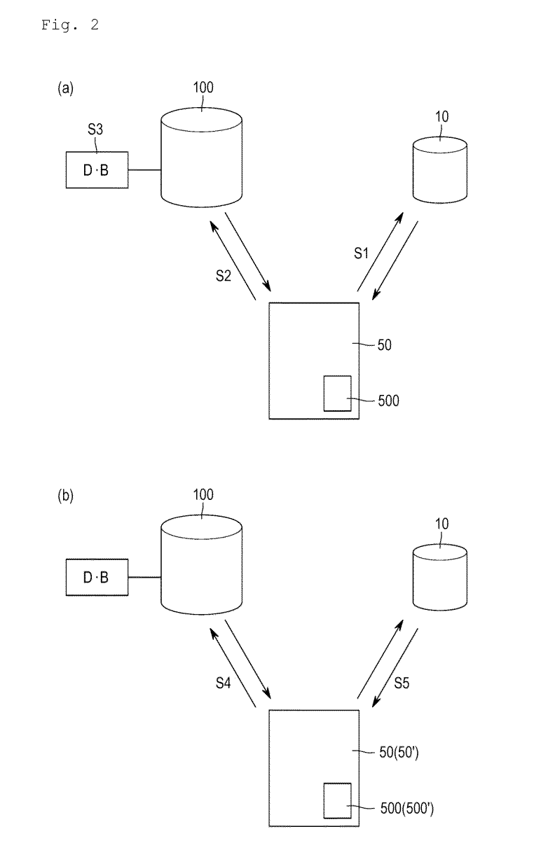

FIG. 2 (a) and (b) show processes for scrapbooking web pages selected by a user from the web pages of the website that the user computer 50 accesses in the scrapbooking system for screens 1000.

Firstly, with reference to FIG. 2 (a), the user computer 50 accesses the website 10 and web page according to the URL that user computer 50 accesses is outputted to the user computer 50. (Step S1)

Then, the scrapbooking service apparatus 500 captures a region that the user establishes on the web page, makes an image file, reads memo inputted in association with the captured region, reads the URL of the web page and transfers the captured image file, memo and the URL of the web page to the scrapbooking service server for screen 100. (Step S2)

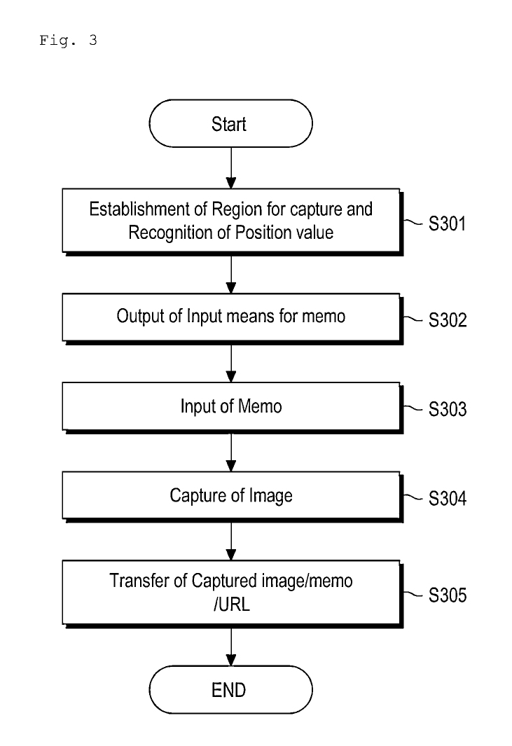

The step S2 is described in detail with reference to FIG. 3.

Firstly, the user establishes the region to be captured by means of an input device for establishing region for capture on the web page outputted to the user computer 50 and the scrapbooking service apparatus 500 in the user computer 50 recognizes position values of the region to be captured. (Step S301)

The establishment of the region can be accomplished by selection of a particular image on the web page outputted to the user computer 50 or by designation of a particular region.

The establishment of the region by the selection of the particular image on the web page outputted to the user computer 50 includes designating an image, if the image is displayed on the web page according to image file for example, by jpg format, by means of the input device. In this case, the scrapbooking service apparatus 500 analyses DOM structure of the web page and calculates the position values of the designated image so that it recognizes the position values. Or the scrapbooking service apparatus 500 extracts an object according to Meta data and recognizes the position values.

The establishment of the region by the designation of the particular region on the web page outputted to the user computer 50 includes designating the region by dragging or like. In this case, the scrapbooking service apparatus 500 calculates and recognizes the position values of the designated region.

The particular image is selected or the particular region is designated on the screen of the web page outputted to a monitor of the user computer by means of the input device for establishing region for capture such as a mouse, a trackball, a touch pad, a light pen or a tablet.

Then, the scrapbooking service server for screen 100 or the scrapbooking service apparatus 500 outputs input means for memo to the user computer 50. (Step S302)

It is preferable that the input means for memo is outputted as the form of input window. The input window has memo part and also has title part so that the user can input memo with the title. It is also possible that the input window does not have the title part and the scrapbooking service apparatus 500 extracts the title from the web page directly.

Then, the user inputs the memo to the input means for memo. (Step S303) In this case, it is not essential that the memo is inputted.

Then, the scrapbooking service apparatus 500 captures the region according to the recognized position values on the web page and makes it to an image file. (Step S304)

Then, the scrapbooking service apparatus 500 reads the URL of the web page and transfers the captured image file, inputted memo and the URL of the web page to the scrapbooking service server 100. (Step S305)

Through the processes, the scrapbooking service apparatus 500 captures the region established by the user on the web page and makes the captured region into the image file, received the input of the memo in connection with the captured region and reads the URL of the web page, and sends all of them to the scrapbooking service server 100.

In this case, it is not necessary to follow the aforementioned sequence. For example, it is possible to capture and make the image file when the region is established on the web pate outputted to the user computer 50, then, output the input means for memo and receive the memo inputted, reads the URL of the web page and transfer the image file, memo and the URL of the web page to the scrapbooking service server 100.

The scrapbooking service server 100 to which the image file captured from the web page, the memo and the URL of the web page are transferred stores them on the database. (Step S3)

In this case, the scrapbooking service server 100, preferably, stores the transferred image file of captured web page, the memo and the URL of the web page in association with the user scrapbooking the web page. Generally, the scrapbooking service server 100 requests log-in of the user to identify the user and stores the transferred image file of captured web page, the memo and the URL of the web page in association with the identified user.

Through the processes, each of the users stores the captured image file of the web pages that the user wants to scrapbook, related memo and the URL of the web pages in the scrapbooking service server for screen 100.

Then, with respect to FIG. 2 (b), the user or other user accesses the scrapbooking service server for screen 100 through the user computer 50 or another user's computer 50′ and the scrapbooking service server for screen 100 outputs and displays the captured image of the web page, the memo and the link to the URL of the web page in association with the user to the user computer 50 or another user's computer 50′ as the post in the bulletin board. (Step S4)

That is, the scrapbooking service server for screen 100 is a server providing the electronic bulletin board service which outputs the post containing the captured image of the web page, the memo and the link to the URL of the web page.

As well known, the electronic bulletin board service is a service provided by a server having display form for electronic bulletin board already defined by description language such as html to store posts that users upload through their computers, outputs them to the user computers and stores and outputs the comments from the user computers according to the defined display form for electronic bulletin board.

According to the present invention, the display form for the bulletin board is, preferably, the tile view form where the images of the captured web page, the user uploads, are displayed by the form of thumb nail and the memos are seen below thereof and the comments are shown below the memos. The list form is also available.

Also, it is preferable that each of the posts has a title and the title contains the link internally so that the click of the title causes the movement to the URL of the web page.

As described, the title is the thing extracted from the web page directly and transferred by the scrapbooking service apparatus 500 or is the thing inputted to the title part of the input means for memo by the user.

Then, the user computer 50 or another user computer 50′ follows the link to the URL on the post and accesses the URL of the web page so that it is possible to see the original web page. (Step S5)

As described, the scrapbooking service server 100 for screen outputs the image of the web page captured by the user, the memo related to the webpage and the link to the URL of the web page on the bulletin board as the post. The user or another user can access the original web page through the link and add the comments, talk and share each other for the post of the scrapbooked web page.

Also, it is preferable that the electronic bulletin board provided by the scrapbooking service server for screen 100 is linked to another electronic bulletin board of which the API is open, such as the electronic bulletin board of the Facebook providing SNS service so that the post can be submitted to the another electronic bulletin board of which the API is open.

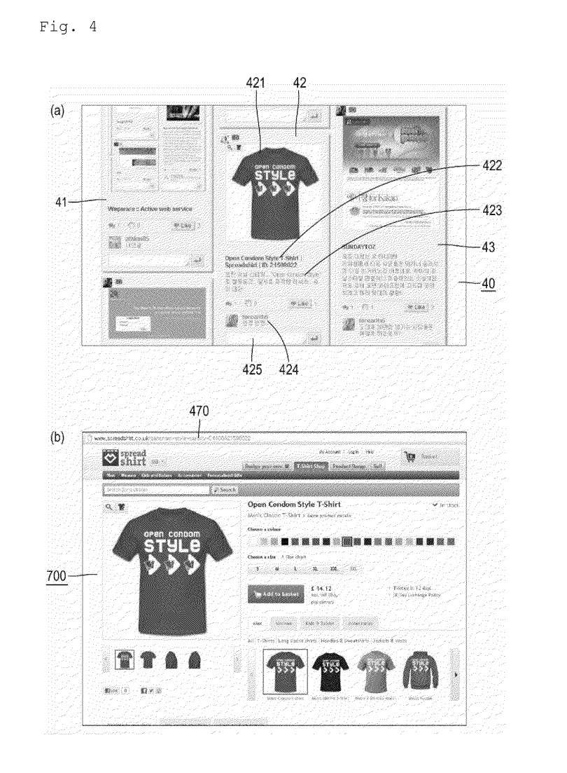

FIG. 4 (a) shows an exemplary form of the electronic bulletin board outputted by the scrapbooking service server 100 to the user computer 50.

As shown, numbers of posts 41, 42 and 43 are displayed by the tile-view form. As for the post 42, thumb-nail sized captured image 421 is displayed and its title is shown below. Memo 423 inputted by the relevant user is also shown below and comment 424 is added below. Comment input form 425 is also shown.

Meanwhile, the title 422 contains the link to the URL of the original web page. If the user clicks it, original web page 700 according to the URL of the original web page is outputted as shown in FIG. 4(b). The URL of the original web page 470 is found on the upper part of the original web page 700.

Also, according to the present invention, instead of directly accessing the URL of the original web page through the link, it is possible to call and have the original web page assembled into the output display of the post scrapbooking the web page to be displayed on the output display of the scrapbooking service server for screen 100. This is accomplished by the web site section assembling system and method for the same, which is filed by PCT/KR2011/003689.

Meanwhile, according to the present invention, it is possible to make videos, images, flashes or documents outputted to the user computer into images and post them to the scrapbooking service server for screen 100, and introduce them to and share them with others.

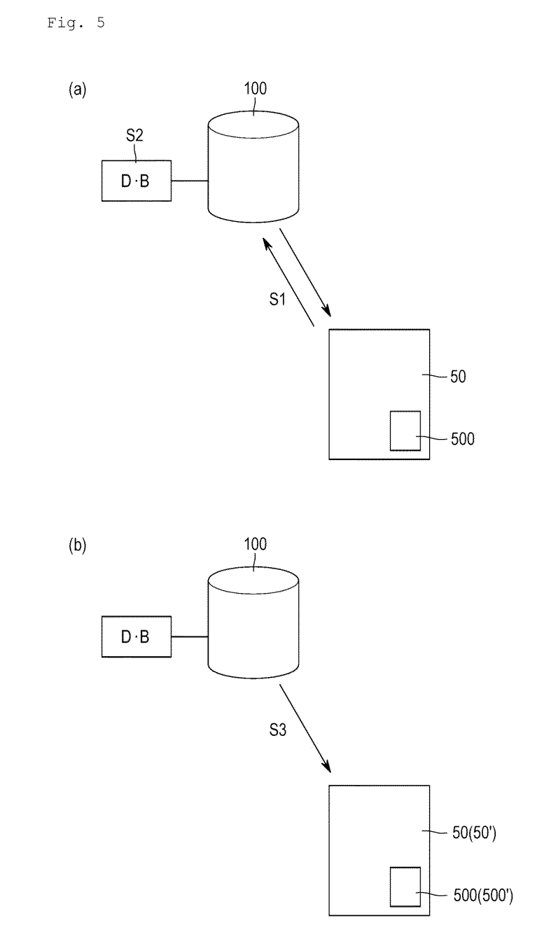

FIG. 5 (a) and (b) show processes for this case. Firstly, with reference to FIG. 5 (a), the scrapbooking service apparatus 500 of the user computer 50 captures region established by the user on the output display of the videos, images, flashes or documents outputted to the user computer, makes them into image files, and reads memo inputted in connection with the captured and transfers the captured image files and the memo inputted to the scrapbooking service server for screen 100. (Step S1)

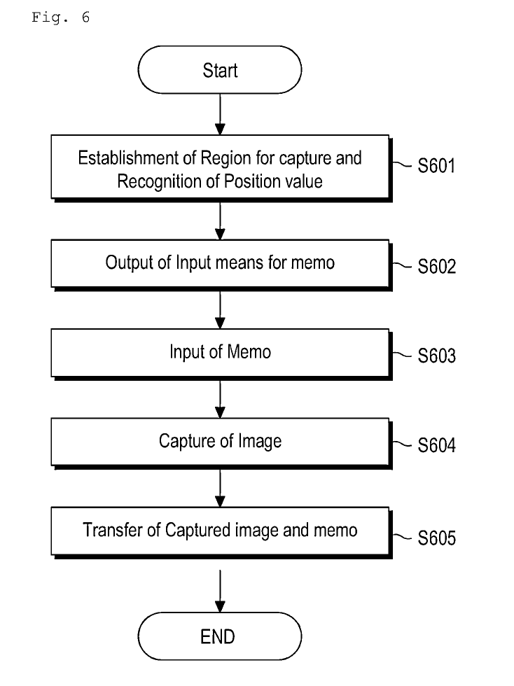

The step S1 is explained with reference to FIG. 6.

Firstly, the user establishes the region for capture on the display of the videos, flashes, images and documents outputted to the user computer 50 by means of the input device for establishing the region for capture and the scrapbooking service apparatus 500 in the user computer 59 recognizes the position values of the region for capture. (Step S601)

The user computer 50 can establish the region on the display outputted to the monitor of the user computer by means of the input device such as the mouse, trackball, touch pad, light pen or tablet, which are used for establishing the region for capture, then the scrapbooking service apparatus 500 in the user computer 59 recognizes the position values of the capture region.

Then, the scrapbooking service server for screen 100 or the scrapbooking service apparatus 500 outputs the input means for memo to the user computer 50. (Step S602)

It is preferable that the input means for memo is outputted as the form of input window. The input window has memo part and also has title part so that the user can input memo with the title.

Then, the user inputs the memo to the input means for memo outputted to the user computer 50. (Step S603) In this case, it is not essential that the memo is inputted.

Then, the scrapbooking service apparatus 500 captures the region according to the position values of the established capture region and makes it into an image file. (Step S604)

Then, the scrapbooking service apparatus 500 transfers the captured image file and the memo inputted to the scrapbooking service sever for screen 100. (Step S605)

Through these processes, the scrapbooking service apparatus 500 captures the region established by the user on the output display of the user computer 50 and makes it into the image file and receives the memo in association with the capture region, and transfers them to the scrapbooking service server for screen 100.

In this case, it is not essential to follow the aforementioned sequence. For example, it is possible to capture and make the image file when the region is established on the web pate outputted to the user computer 50, then, output the input means for memo and receive the memo inputted, and transfer the image file and the memo to the scrapbooking service server 100.

The scrapbooking service server for screen 100 to which the captured image file and the memo are transferred stores them on database. (Step S2)

In this case, the scrapbooking service server for screen 100 produces URL of the web page where the captured image and the memo are displayed as post under its URL and stores the image file and the memo in association with the URL of the web page. Also, it is general to store them in association with the user who is logged in.

Through the processes, the user can store the image files captured from the videos, the images, the flashes and the documents outputted to the user computer 50 by his or her interesting region and the relevant memos on the scrapbooking service server for screen 100.

Then, with reference to FIG. 5 (b), the user or another user accesses the scrapbooking service server for screen 100 through the user computer 50 or the another user's computer 50′ and the scrapbooking service server 100 outputs the captured image and the relevant memo as the post to the user computer 50 or the another user's computer 50′ to display them. (Step S3)

In this case, it is preferable that the form of the bulletin board is the tile-view form where the captured images that the user submits are displayed by the thumb nail sized. They can be displayed by the list form.

The user or other users can submit comments and talk and share them for the images of the output displays of the user computer and the relevant memo outputted to the bulletin board as the post.

According to the present invention, the web page can be scrapbooked by only establishing the region for capture on the web page so that the scrapbooking is easily achieved.

Also, the captured web page is published on the electronic bulletin board as the poser and can have the comments added thereto so that the scrapbooked web pages can be easily searched and talked with others.

Further, according to the present invention, the post of the scrapbooked web page contains the link to the URL of the original web page and it is possible to access the original web page through the link and to see it faithfully.

Especially, according to the present invention, the region of the web page is captured to be posted on the bulletin board and user will capture the region expressing the subject or which is the significant part. Therefore, the image of the captured web page posted on the bulletin board is the most effective cover page showing the identity of the scrapbooked web page. The user can capture the part which the user wants and has interest in from the displayed screen regardless of particular metadata (image, text and video objects). For example, a photo on the web page can be captured or a part of the photo and a part of the description to the photo on the web page can be captured at the same time.

Especially, according to the present invention, a memo is written along with the capture of some region of the web page and the memo with the captured image of the web page is posted so that the posted scrapbooked web page shows the identity very well.

Accordingly, the present invention provides the way to scrapbook the web page in such a way to show its identity very well and search it easily.

Further, the present invention makes it possible to capture videos, images, flashes or documents besides web pages, upload the captured on the scrapbooking service server to output them as posts and share them with others.

We claim:

1. A method for scrapbooking a web page comprising the steps of:
(a) a web page screen output step wherein a web page according to URL which a user computer accesses is outputted to the user computer, wherein the user computer has a web browser and scrapbooking service apparatus;
(b) a capture step wherein the scrapbooking service apparatus captures a region established by a user on the web page outputted to the user computer and makes the captured region into an image file, and reads the URL of the web page;
(c) a capture image transfer step wherein the scrapbooking service apparatus transfers the image file and the URL of the web page to a scrapbooking service server;
(d) a database storage step wherein the scrapbooking service server stores the transferred image file captured from the web page and the URL of the web page on a database;
(e) a bulletin board output step wherein the image captured from the web page and a link to the URL of the web page, the image and the URL stored on the database, are outputted to the user computer or another user's computer which accesses the scrapbooking service server as a post of an electronic bulletin board.

2. The method for scrapbooking a web page as claimed in claim 1 wherein the capture step further includes a memo read step wherein the scrapbooking service apparatus reads a memo inputted to an input means for memo outputted to the user computer, the capture image transfer step is that the scrapbooking service apparatus transfers the memo along with the image file and the URL of the web page and the bulletin board output step is to post the memo along with the image captured from the web page and the link to the URL of the web page.

3. The method for scrapbooking a web page as claimed in claim 1 wherein the user of the user computer or another user of another user computer accesses the URL of the web page through the link to the URL of the web page and sees the original web page.

4. The method for scrapbooking a web page as claimed in claim 3 wherein the scrapbooking service apparatus's capturing a region established by a user on the web page outputted to the user computer and making the captured region into the image file includes that, when the user selects a particular image outputted to the user computer by means of an input device for establishing region for capture, the scrapbooking service apparatus analyses DOM structure of the web page and calculates position values of the selected image and captures the region according to the position values, that the scrapbooking service apparatus extracts objects according to meta data or that, when the user designates particular region on the web page outputted to the user computer by means of the input device for establishing region for capture, the scrapbooking service apparatus calculates the position values of the designated region and captures the region according to the position values.

5. The method for scrapbooking a web page as claimed in claim 3 further comprising the steps of:
(a) a capture of output of user computer and transfer step wherein the scrapbooking service apparatus captures a region established by the user on the output display other than the web page outputted to the user computer and makes the captured into an image file, reads a memo inputted to input means for memo outputted to the user computer and transfers the capture image and the memo to the scrapbooking service server;
(b) a database storage step wherein the scrapbooking service server stores the transferred image file captured from the output of the user computer and the memo on a database; and
(c) a bulletin board output step wherein the image captured from the output of the user computer and the memo stored on the database are outputted to the user computer or another user's computer which accesses the scrapbooking service server as a post of the electronic bulletin board.

6. The method for scrapbooking web page as claimed in claim 5 wherein the output of the user computer includes one selected from videos, images, flashes or documents or a combination of them.

7. The method for scrapbooking web page performed by a scrapbooking service server comprising the steps of:
(a) a database storage step wherein an image file and URL of a web page are stored on a database, the image file and the URL of the webpage produced and transferred to the scrapbooking service server in such a way that when the web page according to the URL to which a user computer accesses is outputted to the user computer having a web browser and scrapbooking service apparatus, the scrapbooking service apparatus captures region established by a user on the web page outputted to the user computer and makes the captured region into the image file, and reads the URL of the web page, and the scrapbooking service apparatus transfers the image file and the URL of the web page thereto;
(b) a bulletin board output step wherein the image captured from the web page and link to the URL of the web page, the image and the URL stored on the database, are outputted to the user computer or another user's computer as a post of an electronic bulletin board.

8. The method for scrapbooking web page performed by a scrapbooking service server as claimed in claim 7 further comprising the steps of:
(a) a database storage of output display step wherein an image file and a memo are stored on a database, the image file and the memo produced and transferred to the scrapbooking service server in such a way that the scrapbooking service apparatus captures region established by the user on the output display other than the web page outputted to the user computer and makes the captured into the image file, reads the memo inputted to input means for memo outputted to the user computer and transfers the capture image and the memo thereto;
(b) a bulletin board output step wherein the image captured from the output of the user computer and the memo stored on the database are outputted to the user computer or another user's computer as a post of the electronic bulletin board.

9. The method for scrapbooking web page performed by scrapbooking service server as claimed in claim 8 wherein the database storage step is to store a memo along with the image file and the URL of the webpage on the database, the memo produced and transferred to the scrapbooking service server in such a way that the scrapbooking service apparatus reads the memo inputted to input means for memo outputted to the user computer and transfers thereto as well as capturing the region and making the captured region into the image file, and reading the URL of the web page, and transferring the image file and the URL of the web page thereto and the Bulletin board output step is to output the memo along with the image captured from the web page and link to the URL of the web page as the post of the electronic bulletin board.
